(19) United States
(12) Patent Application Publication
(10) Pub. No.: US 2003/0002691 A1
(43) Pub. Date: Jan. 2, 2003

(54) High-frequency current suppressor capable of being readily attached to cable or the like and earphone system using the same

(76) Inventors: Hiroshi Ono, Sendai-shi (JP); Shigeyoshi Yoshida, Sendai-shi (JP)

Correspondence Address: Frishauf Holtz Goodman Langer & Chick, 767 Third Avenue 25th floor, New Yor, NY, 10017-2023, US

(21) Appl. No.: 10/018,148

(22) PCT Filed: Jul. 17, 2001
(86) PCT No.: PCT/JP01/03271

(30) Foreign Application Priority Data
Apr. 17, 2000 (JP) 2000-114912
Apr. 27, 2000 (JP) 2000-127191

(51) Int. Cl. H04B 15/00

(52) U.S. Cl. 381/94.1

(57) ABSTRACT

An earphone system 201 comprises an earphone 211, a microphone 212, a connection plug 213, a signal cable 214 for connecting those, and a hollow cylindrical high-frequency current suppressor 215 attached to the signal cable 214 at a position near the earphone 211 with covering an external circumuferencial surface 216a of the cable housing 216. When used for a terminal equipment for mobile communication, high-frequency current generated by electromagnetic waves produced from the terminal equipment can be reduced. The earphone system 201 can prevent an increase of SAR value in human head.

### TECHNICAL FIELD

The present invention relates to a high-frequency current suppressor for suppressing high-frequency conduction noise in a signal transmission cable used for various electronic information equipment, such as a terminal equipment for mobile communication, an audio-visual equipment, or the like, and also to an earphone system using the high-frequency current suppressor.

### BACKGROUND ART

Conventionally, various signal transmission cables are used for transmitting signals between devices or between components in various electronic information equipment.

On the other hand, in various audio-visual equipment for enjoying music or movies, an earphone system including a signal transmission cable having a connection plug at its end, earphone or headphone is utilized to enable a user to enjoy music or movies without worrying about surrounding sound.

Further, an earphone system combining the above-described earphone or headphone for enjoying music etc. and a microphone has been used in recent years, for example, in a terminal equipment for mobile communication, such as a portable telephone, or the like. This makes hands-free communication available, namely makes it unnecessary for a user to hold the terminal equipment for mobile communication directly in his hand.

The earphone system including those earphones or headphones generally comprises a connection plug connected to an output terminal of a terminal equipment, an earphone or a headphone and/or a microphone, and a signal cable for connecting the connection plug with the earphone, or the like. A cable length of the signal cable ranges from several tens centimeters to a hundred and several tens centimeters. In addition, the cable length corresponds to order of wavelength in microwave band used for mobile communication.

However, an output from antenna attached to a terminal equipment for mobile communication, such as a portable telephone, or the like is easily conducted to the signal cable of the earphone system due to electromagnetic coupling. As a result, electromagnetic wave is conducted to a head of the user through the signal cable. This sometimes increases localized SAR (absorbed electric power per specific weight) value.

Thus, electromagnetic waves produced from a terminal equipment for mobile communication or the like cause a problem in which an influence of the electromagnetic waves to a human body becomes serious.

Various researches have been made in recent years as regards such an influence of the electromagnetic waves to a human body. It is sure that the influence would become serious problem more and more from now on in accordance with further popularization of the mobile communication equipment. In addition, unnecessary high-frequency noise (current) is sometimes conducted to a signal cable used for transmitting signals between devices or between components in various electronic information equipment. An erroneous operation of electronic information equipment is thereby caused to occur.

It is therefore an object of the present invention to provide a high-frequency current suppressor which is capable of being readily attached to a signal cable used for transmitting signals between devices or between components in various electronic information equipment and which can prevent the electronic information equipment from erroneous operations by reducing unnecessary high-frequency current conducted to the signal cable.

It is another object of the present invention to provide a high-frequency current suppressor which is capable of being readily attached to an earphone, a signal cable, or the like, and which can prevent electromagnetic wave from increasing SAR value in a human head by reducing unnecessary high-frequency current generated in the signal cable due to induction of the electromagnetic wave produced from a terminal equipment, and the like, and also to provide an earphone system using the high-frequency current suppressor.

### DISCLOSURE OF THE INVENTION

According to an aspect of the present invention, as described in claim 1, there is provided a high-frequency current suppressor comprising a flexible member capable of being attached to a cable.

As described in claim 2, it is preferable that the flexible member comprises a break, which elongates over all length along an axial direction of the cable.

As described in claim 3, the high-frequency current suppressor may comprise at least two layers which consist of a high-frequency current suppressing layer and at least one outer layer. As described in claim 4, the outer layer may be consisting of either a molded resin or a molded metal, or combination of the molded resin and the molded metal.

As described in claim 5, the high-frequency current suppressor may be consisting of composite magnetic material which comprises soft magnetic powder obtained by flattening alloy powder including at least Fe, Si, Al, and binding material.

As described in claim 6, the high-frequency current suppressor may be consisting of composite magnetic material which comprises soft magnetic powder obtained by flattening alloy powder including at least Ni, Fe, and binding material.

As described in claim 7, the high-frequency current suppressor may be consisting of magnetic loss thin film which comprises a first member consisting of at least any one of Fe, Co, Ni, or mixture thereof and a second member consisting of insulating material including at least more than one kinds of elements other than Fe, Co, Ni.

As described in claim 8, an earphone system for use in a terminal of mobile communication may be provided with the high-frequency current suppressor as claimed in any one of the claims 1 through 7.

Besides, “earphone system” depicted in the present invention includes not only a system having one earphone (for use in a single ear) or two earphones (for use in both ears) but also another system having, what we call, a headphone combining two earphones (for use in both ears) and a head band etc.

According to another aspect of the present invention, as described in claim 9, there is provided an earphone system comprising a connection plug connected to an output terminal of an electronic equipment, an earphone, and a signal cable for connecting the connection plug with the earphone, wherein a high-frequency current suppressor consisting of soft magnetic material is added at least partially to any one of the connection plug, the earphone, and the signal cable.

As described in claim 10, a part or a whole of outer circumference of the signal cable may be covered by the high-frequency current suppressor.

As described in claim 11, a part or a whole of outer circumference of an outer conductor of the signal cable may be covered by the high-frequency current suppressor.

As described in claim 12, the high-frequency current suppressor may be provided near a portion where the signal cable and the earphone are connected to each other.

As described in claim 13, the high-frequency current suppressor may be included inside the earphone.

As described in claim 14, the earphone system may further comprise a microphone.

As described in claim 15, the high-frequency current suppressor may be included inside the microphone.

As described in claim 16, a housing of the earphone or the microphone may be formed by the high-frequency current suppressor.

As described in claim 17, the high-frequency current suppressor may be consisting of composite magnetic material which comprises soft magnetic powder obtained by flattening alloy powder including at least Fe, Si, Al, and binding material.

As described in claim 18, the high-frequency current suppressor may be consisting of composite magnetic material which comprises soft magnetic powder obtained by flattening alloy powder including at least Ni, Fe, and binding material.

As described in claim 19, the high-frequency current suppressor may be consisting of magnetic loss thin film which comprises a first member consisting of at least any one of Fe, Co, Ni, or mixture thereof and a second member consisting of insulating material including at least more than one kinds of elements other than Fe, Co, Ni.

### BRIEF DESCRIPTION OF THE DRAWINGS

FIG. 1 is an explanation view for showing a high-frequency current suppressor according to a first embodiment of the present invention, (a) is a schematic perspective view showing the high-frequency current suppressor, (b) is a schematic perspective view showing a condition in which the high-frequency current suppressor is attached to a cable;

FIG. 2 is a schematic perspective view for showing a high-frequency current suppressor according to a second embodiment of the present invention;

FIG. 3 is a schematic perspective view for showing a high-frequency current suppressor according to a third embodiment of the present invention;

FIG. 4 is a schematic perspective view for showing a high-frequency current suppressor according to a fourth embodiment of the present invention;

FIG. 5 is a view for showing suppressing effects against high-frequency electromagnetic waves in the high-frequency current suppressor according to the first through the fourth embodiments of the present invention;

FIG. 6 is an explanation view for showing an earphone system according to a fifth embodiment of the present invention, (a) is a schematic perspective view showing the earphone system, (b) is an enlarged view showing a high-frequency current suppressor thereof;

FIG. 7 is an explanation view for showing an earphone system according to a sixth embodiment of the present invention, (a) is a schematic perspective view showing the earphone system, (b) is an enlarged view showing a high-frequency current suppressor thereof;

FIG. 8 is an explanation view for showing an earphone system according to a seventh embodiment of the present invention, (a) is a schematic perspective view showing the earphone system, (b) is an enlarged view showing a high-frequency current suppressor thereof;

FIG. 9 is an explanation view for showing an earphone system according to an eighth embodiment of the present invention, (a) is a schematic perspective view showing the earphone system, (b) is an enlarged sectional view showing an earphone thereof;

FIG. 10 is an enlarged sectional view for showing a microphone of an earphone system according to an ninth embodiment of the present invention;

FIG. 11 is an enlarged view for showing an earphone of an earphone system according to a tenth embodiment of the present invention;

FIG. 12 is an enlarged view for showing a microphone of an earphone system according to an eleventh embodiment of the present invention; and

FIG. 13 is a view for showing measuring effects of suppressing effect against high-frequency electromagnetic waves in the earphone system using the high-frequency current suppressor according to the fifth through the ninth embodiments of the present invention.

### BEST MODE FOR EMBODYING THE INVENTION

(First Embodiment)

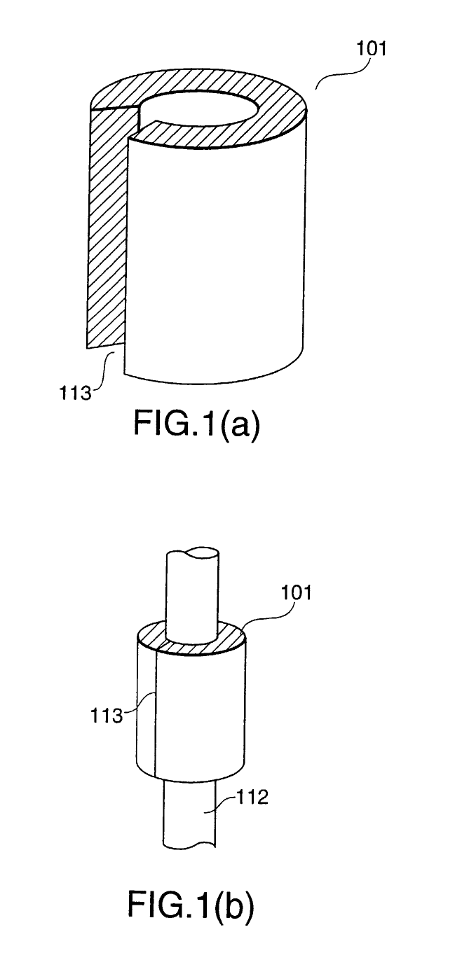

Referring to FIGS. 1(a) and 1(b), description is, at first, made about a high-frequency current suppressor according to a first embodiment of the present invention.

In FIG. 1(a), a high-frequency current suppressor 101 is essentially consisting of a composite magnetic material which comprises soft magnetic powder obtained by flattening alloy powder including Fe, Si, Al, and a binding material. The composite magnetic material is subjected to press molding to have a cylindrical shape having a size of 1.5 mm in inner diameter, 2.65 mm in outer diameter, and 10.0 mm in length. The composite magnetic material has a break 113 which elongates length direction of the cylindrical shape in a part thereof. The composite magnetic material is thereby formed to have flexibility.

On the other hand, FIG. 1(b) shows a condition in which the high-frequency current suppressor 101 consisting of this composite magnetic material is attached to a signal cable 112 having a size of approximately 1.5 mm in outer diameter. The high-frequency current suppressor 101 has flexibility, as mentioned above. Let the break 113 of the high-frequency current suppressor 101 be opened by a hand or fingers to be attached to the signal cable 112 and release the high-frequency current suppressor 101 from the hand or fingers. Accordingly, the high-frequency current suppressor 101 is adhered and fixed to the signal cable 112.

In the interim, suppressing effects against high-frequency current was investigated as regards the high-frequency current suppressor 101 according to this embodiment, after the high-frequency current suppressor 101 was fixed to the signal cable 112. As a result, a suppressing effect of −17 dB is obtained at such a frequency band of 900 MHz as used for mobile communication while another suppressing effect of −27 dB is obtained at such a frequency band of 1.9 GHz as also used therefor.

In the first embodiment, the high-frequency current suppressor 101 is consisting of the composite magnetic material which comprises soft magnetic powder obtained by flattening alloy powder including Fe, Si, and Al, and a binding material. However, the alloy powder is not required to include all of Fe, Si, and Al. The alloy powder is required to include at least any one of Fe, Si, Al.

(Second Embodiment)

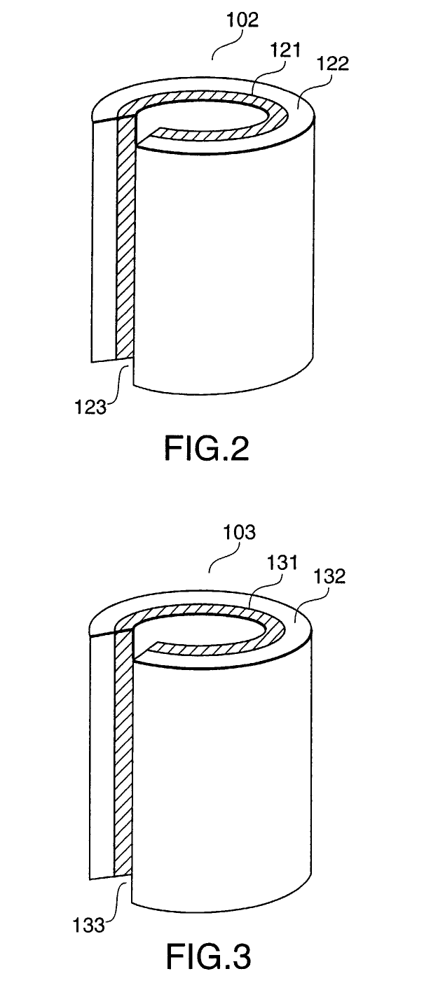

Next, referring to FIG. 2, description will proceed to a high-frequency current suppressor according to a second embodiment of the present invention.

In FIG. 2, a high-frequency current suppressor 102 comprises two layers which consist of a high-frequency current suppressing layer 121 and a resin outer layer 122. The high-frequency current suppressing layer 121 is essentially consisting of a composite magnetic material to have flexibility, similar to that of the first embodiment. An outer circumference of the high-frequency current suppressing layer 121 is covered by the resin outer layer 122 consisting of molded resin having a thickness of approximately 0.5 mm to have flexibility.

Also in the high-frequency current suppressor 102, similarly to the first embodiment, both the high-frequency current suppressing layer 121 and the resin outer layer 122 have flexibility. Let the break 123 of the high-frequency current suppressor 102 be opened by a hand or fingers to be attached to the signal cable 112(See FIG. 1) and release the high-frequency current suppressor 102 from the hand or fingers. Accordingly, the high-frequency current suppressor 102 is adhered and fixed to the signal cable 112(See FIG. 1).

Further, suppressing effects against high-frequency current was investigated as regards the high-frequency current suppressor 102, after being fixed to the signal cable 112(See FIG. 1). As a result, a suppressing effect of −18 dB is obtained at such a frequency band of 900 MHz as used for mobile communication while another suppressing effect of −29 dB is obtained at such a frequency band of 1.9 GHz as also used therefor.

(Third Embodiment)

Continuously, referring to FIG. 3, description proceeds to a high-frequency current suppressor according to a third embodiment of the present invention.

In FIG. 3, a high-frequency current suppressor 103 comprises two layers which consist of a high-frequency current suppressing layer 131 and an aluminum outer layer 132. The high-frequency current suppressing layer 131 is essentially consisting of a composite magnetic material to have flexibility, similar to that of the first embodiment. An outer circumference of the high-frequency current suppressing layer 131 is covered by the aluminum outer layer 132 consisting of molded aluminum having a thickness of approximately 0.3 mm to have flexibility.

Also in the high-frequency current suppressor 103, similarly to the second embodiment, both the high-frequency current suppressing layer 131 and the aluminum outer layer 132 have flexibility. Let the break 133 of the high-frequency current suppressor 103 be opened by a hand or fingers to be attached to the signal cable 112(See FIG. 1) and release the high-frequency current suppressor 103 from the hand or fingers. Accordingly, the high-frequency current suppressor 103 is adhered and fixed to the signal cable 112(See FIG. 1).

Further, suppressing effects against high-frequency current was investigated as regards the high-frequency current suppressor 103, after being fixed to the signal cable 112(See FIG. 1). As a result, a suppressing effect of −17 dB is obtained at such a frequency band of 900 MHz as used for mobile communication while another suppressing effect of −32 dB is obtained at such a frequency band of 1.9 GHz as also used therefor.

As described above, the outer layer 122 is consisting of molded resin in the second embodiment while the outer layer 132 is consisting of molded metal (aluminum) in the third embodiment. However, the outer layer can be consisting of combination of both resin and metal.

(Fourth Embodiment)

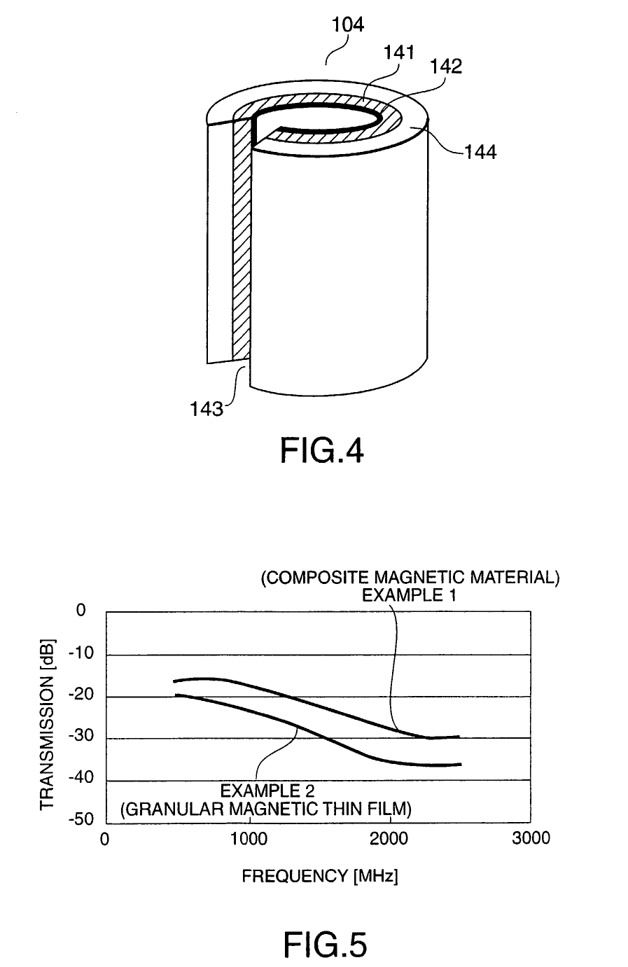

Further, referring to FIG. 4, description proceeds to a high-frequency current suppressor according to a fourth embodiment of the present invention.

In FIG. 4, a high-frequency current suppressor 104 has three-layers structure which comprises a high-frequency current suppressing layer 141, a polyimide base material 142 and a resin outer layer 144. The high-frequency current suppressing layer 141 has flexibility and is consisting of magnetic loss thin film (granular magnetic thin film) composed of Fe₇₂Al₁₁O₁₇. The polyimide base material 142 has a thickness of approximately 0.2 mm to have flexibility. The resin outer layer 144 is consisting of molded resin having a thickness of approximately 0.5 mm to have flexibility. In order to fabricate these three-layers structure, at first, the high-frequency current suppressing layer 141 is formed on a surface of the polyimide base material 142 by sputtering to have a film thickness of 1.5 μm. Thereby, the high-frequency current suppressing layer 141 and the polyimide base material 142 are formed to have a cylindrical shape having approximately 1.5 mm in inner diameter, and approximately 10.0 mm in length. An outer circumference of the high-frequency current suppressing layer 141 is then covered by the resin outer layer 144 consisting of molded resin having a thickness of approximately 0.5 mm to have flexibility.

Also in the high-frequency current suppressor 104, similarly to the second and the third embodiments, all of the high-frequency current suppressing layer 141, the polyimide base material 142 and the resin outer layer 144 have flexibility. Let the break 143 of the high-frequency current suppressor 104 be opened by a hand or fingers to be attached to the signal cable 112(See FIG. 1) and release the high-frequency current suppressor 104 from the hand or fingers. Accordingly, the high-frequency current suppressor 104 is adhered and fixed to the signal cable 112(See FIG. 1).

Further, suppressing effects against high-frequency current was investigated as regards the high-frequency current suppressor 104, after being fixed to the signal cable 112(See FIG. 1). As a result, a suppressing effect of −23 dB is obtained at such a frequency band of 900 MHz as used for mobile communication while another suppressing effect of −35 dB is obtained at such a frequency band of 1.9 GHz as also used therefor.

Herein, FIG. 5 shows suppressing effects against high-frequency electromagnetic waves in the high-frequency current suppressors according to the first through the fourth embodiments.

In FIG. 5, EXAMPLE 1 shows measuring effects of transmission characteristics by a network analyzer between two ports. In these measuring, the high-frequency current suppressors 101, 102 and 103 according to the first through the third embodiments are attached to be fixed to a central portion in the length direction of the cable having 1.5 mm in outer diameter and 300 mm in length. Then, both ends of the cable are connected to the network analyzer, as the above-mentioned two ports.

On the other hand, EXAMPLE 2 shows measuring effect of transmission characteristics by a network analyzer between two ports. In this measuring, the high-frequency current suppressor 104 according to the fourth embodiment is attached to be fixed to the central portion of the cable, and then both ends of the cable are connected to the network analyzer, similarly to the EXAMPLE 1.

As will be understood from FIG. 5, according to EXAMPLE 1 and EXAMPLE 2, suppressing effects between 25 dB and 35 dB can be obtained at quasi-microwave band in any high-frequency current suppressors 101, 102, 103 and 104.

Besides, other than the high-frequency current suppressors 101, 102, 103 and 104, alternative high-frequency current suppressors can be designed by changing material composition or size thereof. Accordingly, desirable suppressing characteristics can be obtained by adapting the material composition or the size of the high-frequency current suppressors to a cable.

Further, other than the high-frequency current suppressors according to the above-mentioned first through fourth embodiments, it will now be readily possible to put this invention into effect in various other manners. For example, a break 113, 123, 133 or 143 was formed to be a substantially straight line parallel to an axis of the cylindrical shape of the high-frequency current suppressors. The break can be formed to have an angle to the axis of the cylindrical shape. In addition, the break can be formed as a curve. Alternatively, the break can be composed of two edges interfitted to each other when the break is closed. In addition, shapes of the high-frequency current suppressors are not limited to the cylindrical shape. The high-frequency current suppressors can be formed to have a rectangular shape. Further, a member for preventing the cable from slipping or an adhesive layer can be provided at inner side of the cylindrical or the rectangular tube.

As described above, according to the first through the fourth embodiments of the present invention, the high-frequency current suppressors 101, 102, 103 or 104 comprises a flexible member capable of being attached to a cable. Furthermore, the flexible member comprises a break which elongates over all length along an axial direction of the cable. The high-frequency current suppressors 101, 102, 103 or 104 can therefore be readily attached and fixed to a signal cable used for an earphone, a microphone, and the other electronic equipments. Excellent suppressing effects can be obtained at quasi-microwave band in any high-frequency current suppressors 101, 102, 103 and 104. Accordingly, it is possible to provide a high-frequency current suppressor which can suppress unnecessary high-frequency current sufficiently and which is thereby effective to solve various EMI (electromagnetic interference) problems. It is also possible to prevent electromagnetic waves from increasing SAR value in a human head by applying the high-frequency current suppressor 101, 102, 103 or 104 to earphone, headphone or a signal cable connecting those to a terminal equipment for mobile communication.

Next, referring to drawings, description will proceed to an earphone system according to a fifth through an eleventh embodiments of the present invention.

(Fifth Embodiment)

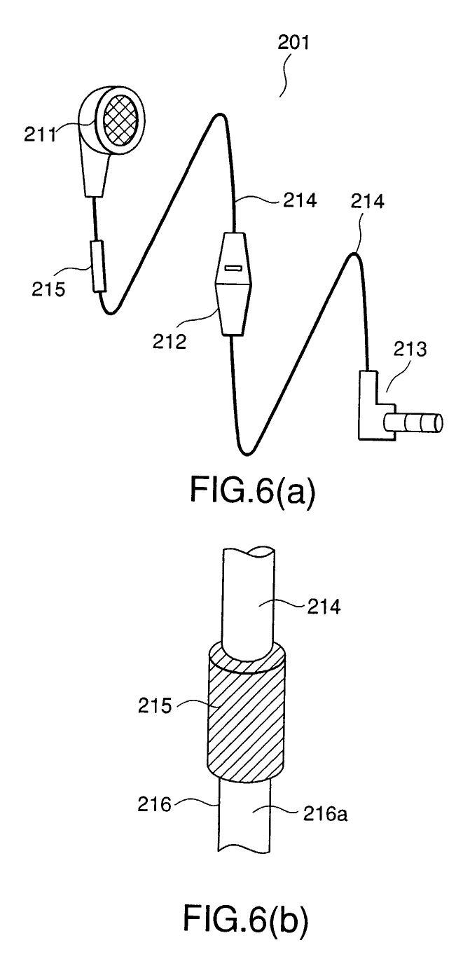

Referring to FIGS. 6(a) and 6(b), description is, at first, made about an earphone system according to a fifth embodiment of the present invention.

As illustrated in FIG. 6(a), an earphone system 201 comprises an earphone 211, a microphone 212, a connection plug 213, and a signal cable 214 for connecting the earphone 211 and the microphone 212 as well as the microphone 212 and the connection plug 213. The signal cable 214 comprises unillustrated an inner conductor, an outer conductor and insulation coating over those inner conductor and outer conductor. Further, as illustrated in FIG. 6(b), the signal cable 214 is overlaid by a cable housing 216 over all of the length thereof. Further, the earphone system 201 comprises a high-frequency current suppressor 215 attached to the signal cable 214 at a position near the earphone 211 with covering an external circumuferencial surface 216a of the cable housing 216 at the position.

The high-frequency current suppressor 215 is formed to have a hollow cylindrical shape having a size of 1.55 mm in inner diameter, 2.20 mm in outer diameter, and 10.0 mm in length, as illustrated in FIG. 6(b). As illustrated in FIGS. 6(a) and 6(b), the high-frequency current suppressor 215 is fixed to the signal cable 214 at the position near the earphone 211 with an internal circumference thereof being adhered to an external circumferencial surface 216a of the cable housing 216.

Herein, the high-frequency current suppressor 215 is consisting of composite magnetic material which comprises soft magnetic powder obtained by flattening alloy powder including Fe, Si, Al, and binding material. The high-frequency current suppressor 215 is formed by press molding to have the above-mentioned hollow cylindrical shape and the size.

(Sixth Embodiment)

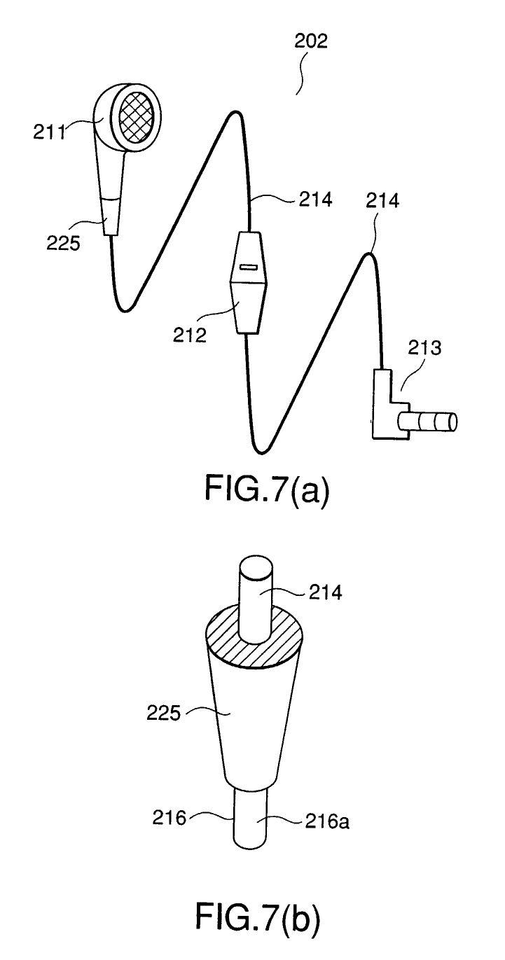

Referring to FIGS. 7(a) and 7(b), description will proceed to an earphone system according to a sixth embodiment of the present invention. The earphone system according to the sixth embodiment has a structure basically similar to that of the fifth embodiment illustrated in FIGS. 6(a) and 6(b). Similar portions are therefore designated by like reference numerals and detailed description thereof is omitted accordingly.

As illustrated in FIG. 7(a), an earphone system 202 comprises a high frequency current suppressor 225 attached to an end of the earphone 211 in series. The high-frequency current suppressor 225 is formed to have a hollow taper shape having a size of 1.55 mm in inner diameter, 3.30 mm in outer diameter of the uppest portions, 2.0 mm in outer diameter of the lowest portions, and 5.5 mm in length of the taper portion, as illustrated in FIG. 7(b). As illustrated in FIGS. 7(a) and 7(b), the high-frequency current suppressor 225 is fixed to the end of the earphone 211 in series with an internal circumference thereof being adhered to an external circumferencial surface 216a of the cable housing 216 of the signal cable 214.

Besides, the high-frequency current suppressor 225 is consisting of composite magnetic material which comprises soft magnetic powder obtained by flattening alloy powder including Fe, Si, Al, and binding material, similarly to the high-frequency current suppressor 215 according to the fifth embodiment. The high-frequency current suppressor 225 is formed by press molding to have the above-mentioned hollow taper shape and the size.

(Seventh Embodiment)

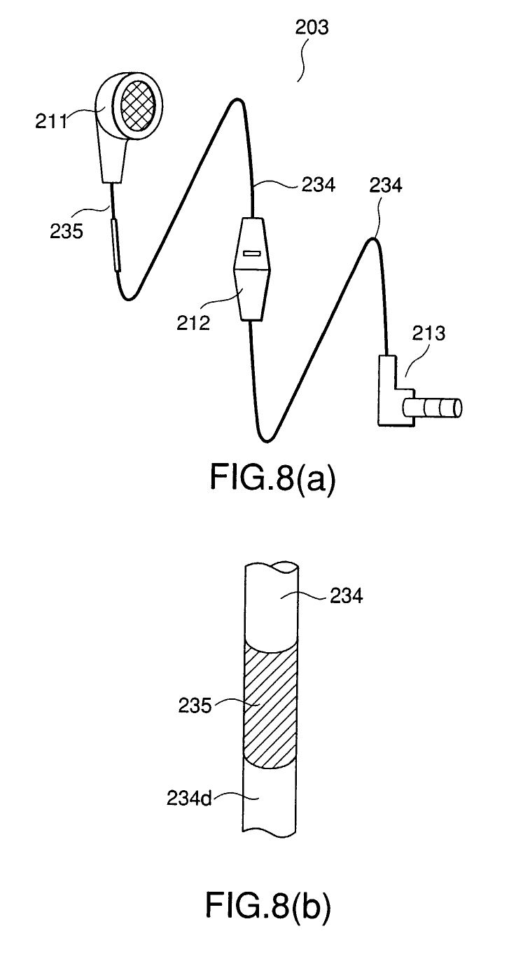

Continuously, referring to FIGS. 8(a) and 8(b), description will proceed to an earphone system according to a seventh embodiment of the present invention. The earphone system according to the seventh embodiment has a structure basically similar to that of the fifth embodiment illustrated in FIGS. 6(a) and 6(b). Similar portions are therefore designated by like reference numerals and detailed description thereof is omitted accordingly.

As illustrated in FIG. 8(a), an earphone system 203 according to the seventh embodiment comprises a high-frequency current suppressor 235 attached to the signal cable 234 at a position near the earphone 211, similarly to that of the above-mentioned fifth embodiment. The signal cable 234 is, what we call, a coaxial cable. The signal cable 234 comprises unillustrated an inner conductor, an outer conductor, an insulation coating layer for insulating the inner conductor from the outer conductor, and an insulation cable housing for coating the outer conductor substantially all over the length thereof [only the insulation cable housing is shown by a reference numeral 234d in FIG. 8(b)]. In this earphone system 203 according to the seventh embodiment, the signal cable 234 includes a portion lacking of the insulation cable housing 234d near the earphone 211, as illustrated in FIGS. 8(a) and 8(b). The high-frequency current suppressor 235 is formed on an exposed surface of the outer conductor in this portion.

Herein, the high-frequency current suppressor 235 is consisting of magnetic loss thin film (granular magnetic thin film) composed of Fe₇₂Al₁₁O₁₇. The high-frequency current suppressor 235 is formed to have a length of 5.5 mm and a film thickness of 1.5 μm on a surface of the outer conductor 234b.

(Eighth Embodiment)

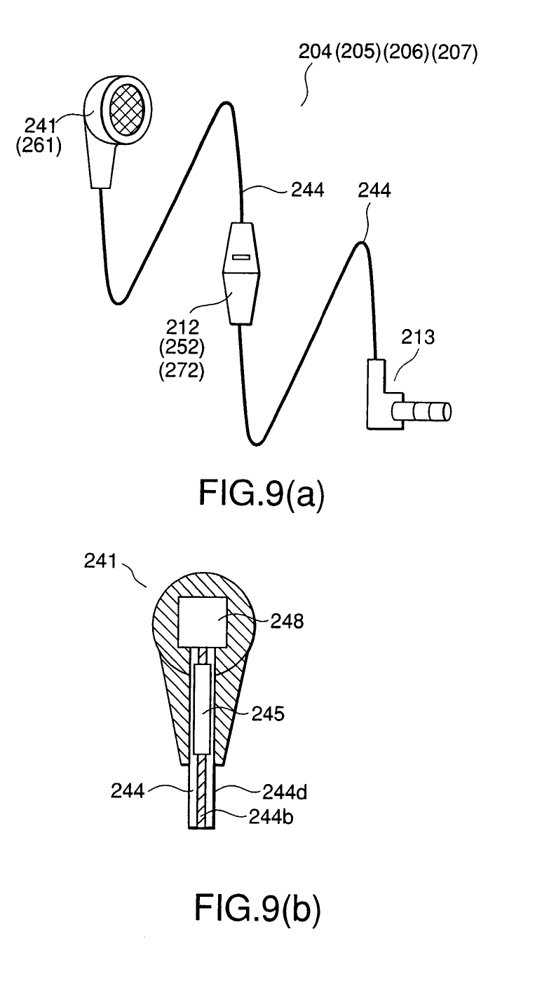

Further, referring to FIGS. 9(a) and 9(b), description will proceed to an earphone system according to a eighth embodiment of the present invention. As illustrated in FIG. 9(a), the earphone system 204 according to the eighth embodiment comprises an earphone 241, a microphone 242, a connection plug 213, and a signal cable 244 for connecting the earphone 241 and the microphone 242 as well as the microphone 242 and the connection plug 213. As illustrated in FIG. 9(b), the earphone 241 comprises a speaker portion 248. Similarly to the signal cable 234 of the above-mentioned seventh embodiment, the signal cable 244 comprises unillustrated an inner conductor, an outer conductor, an insulation coating layer for insulating the inner conductor from the outer conductor, and an insulation cable housing for coating the outer conductor substantially all over the length thereof [only the outer conductor 244b and the insulation cable housing 244d are shown in FIG. 9(b)]. Within the earphone 241, the inner conductor and the outer conductor 244b are connected to the speaker portion 248, respectively.

In this earphone system 204 according to the eighth embodiment, as illustrated in FIG. 9(a), no high-frequency current suppressor is attached to a portion near the earphone 241 or an end of the earphone 241. As illustrated in FIG. 9(b), a high-frequency current suppressor 245 is formed on a surface of the outer conductor 244b, in other words, between the outer conductor 244b and the insulation cable housing 244d.

Further, the high-frequency current suppressor 245 is consisting of magnetic loss thin film (granular magnetic thin film) composed of Fe₇₂Al₁₁O₁₇. The high-frequency current suppressor 245 is formed to have a length of 4.2 mm and a film thickness of 1.9 μm on the surface of the outer conductor 244b.

(Ninth Embodiment)

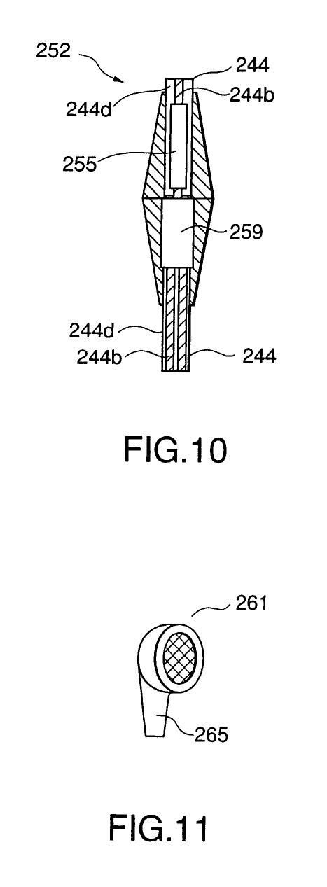

Further, referring to FIG. 10, description will proceed to an earphone system according to an ninth embodiment of the present invention.

The earphone system 205 according to the ninth embodiment has a basic structure similar to that of the eighth embodiment illustrated in FIG. 9(a). Illustration of the basic structure is omitted, but reference numerals of only different portions are designated by parentheses in FIG. 9(a). Namely, as illustrated in FIG. 9(a), the earphone system 205 according to the ninth embodiment comprises an earphone 241, a microphone 252, a connection plug 213, and a signal cable 244 for connecting the earphone 241 and the microphone 252 as well as the microphone 252 and the connection plug 213. As illustrated in FIG. 10, the microphone 252 comprises a microphone portion 259. Within the microphone 252, the inner conductor and the outer conductor 244b are connected to the microphone portion 259, respectively.

In this earphone system 205 according to the ninth embodiment, as illustrated in FIG. 9(a), no high-frequency current suppressor is attached to a portion near the earphone 241 or an end of the earphone 241. As illustrated in FIG. 10, a high-frequency current suppressor 255 is formed on a surface of the outer conductor 244b, in other words, between the outer conductor 244b and the insulation cable housing 244d.

Further, the high-frequency current suppressor 255 is consisting of magnetic loss thin film (granular magnetic thin film) composed of Fe₇₂Al₁₁O₁₇. The high-frequency current suppressor 255 is formed to have a length of 4.2 mm and a film thickness of 1.9 μm on the surface of the outer conductor 244b.

(Tenth Embodiment)

Further, referring to FIG. 11, description will proceed to an earphone system according to a tenth embodiment of the present invention.

The earphone system 206 according to the tenth embodiment has a basic structure similar to the earphone system 204 of the eighth embodiment illustrated in FIG. 9(a). Illustration of the basic structure is omitted, but reference numerals of only different portions are designated by parentheses in FIG. 9(a). Namely, as illustrated in FIG. 9(a), the earphone system 206 according to the tenth embodiment comprises an earphone 261, a microphone 212, a connection plug 213, and a signal cable 244 for connecting the earphone 261 and the microphone 212 as well as the microphone 212 and the connection plug 213.

In this earphone system 206 according to the tenth embodiment, as illustrated in FIG. 9(a), no high-frequency current suppressor is attached to a portion near the earphone 261 or an end of the earphone 261. As illustrated in FIG. 11, a high-frequency current suppressor itself is used as a molded resin constructing a case of the earphone 261.

Herein, the high-frequency current suppressor 265 is consisting of a resin including composite magnetic material which comprises soft magnetic powder obtained by flattening alloy powder including Fe, Si, Al, and binding material. The high-frequency current suppressor 265 is formed by press molding to have a structure illustrated in FIG. 11.

(Eleventh Embodiment)

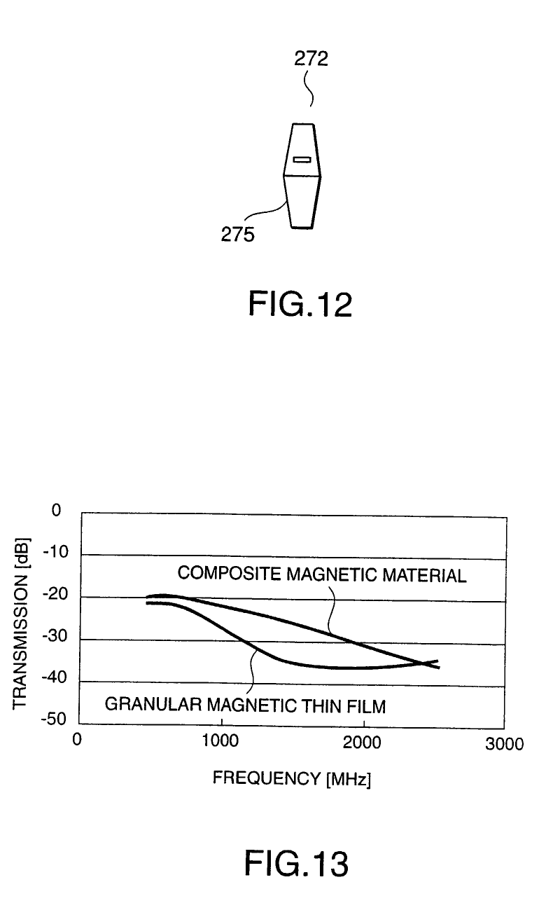

Further, referring to FIG. 12, description will proceed to an earphone system according to an eleventh embodiment of the present invention.

The earphone system 207 according to the eleventh embodiment has a basic structure similar to the earphone system 204 of the eighth embodiment illustrated in FIG. 9(a). Illustration of the basic structure is omitted, but reference numerals of only different portions are designated by parentheses in FIG. 9(a). Namely, as illustrated in FIG. 9(a), the earphone system 207 according to the eleventh embodiment comprises an earphone 241, a microphone 272, a connection plug 213, and a signal cable 244 for connecting the earphone 241 and the microphone 272 as well as the microphone 272 and the connection plug 213.

In this earphone system 207 according to the eleventh embodiment, as illustrated in FIG. 9(a), no high-frequency current suppressor is attached to a portion near the earphone 241 or an end of the earphone 241. As illustrated in FIG. 12, a high-frequency current suppressor itself is used as a molded resin constructing a case of the microphone 272.

Herein, the high-frequency current suppressor 275 is consisting of a resin including composite magnetic material which comprises soft magnetic powder obtained by flattening alloy powder including Fe, Si, Al, and binding material. The high-frequency current suppressor 275 is formed by press molding to have a structure illustrated in FIG. 12.

Hereinunder, description will proceed to operations and effects of the earphone system according to the fifth through the eleventh embodiments of the present invention. FIG. 13 shows measuring effects of suppressing effect against high-frequency electromagnetic waves in the earphone system using the high-frequency current suppressor according to the fifth through the eleventh embodiments.

In the measurement, at first, a tube having 2.5 mm in diameter and 15 mm in length, which has in its central a through hole having 0.5 mm in diameter is prepared. Next, a copper wire having 0.5 mm in diameter and 300 mm in length is penetrated through the through hole. The composite magnetic material is then attached to a central portion of the copper wire in the length direction thereof to obtain a primary line including a primary high-frequency current suppressor (depicted as “composite magnetic material” in FIG. 13). On the other hand, a granular magnetic thin film used in the seventh and the eighth embodiments is formed by sputtering on a external circumference of the above-mentioned copper line to have a length of 15 mm to obtain a secondary line including a secondary high-frequency current suppressor (depicted as “granular magnetic thin film” in FIG. 13). Both ends of the primary line including the primary high-frequency current suppressor are connected to a network analyzer to investigate transmission characteristics between two ports. Also both ends of the secondary line including the secondary high-frequency current suppressor are connected to the network analyzer to investigate transmission characteristics between two ports.

As a result, suppressing effects between 20 dB and 35 dB can be obtained at quasi-microwave band in any of the primary and the secondary high-frequency current suppressors. Besides, other than the high-frequency current suppressors depicted in the above embodiments, larger suppressing effects can be obtained by changing material composition or size thereof.

As described above, according to the earphone system of the fifth through the eleventh embodiments of the present invention, a high-frequency current suppressor is added to an earphone or a microphone itself, alternatively, to a part of a signal cable for connecting the earphone or the microphone into a terminal equipment for mobile communication. High-frequency current generated in a signal cable by electromagnetic waves produced from the terminal equipment can be reduced. Therefore, it becomes possible to provide an earphone system which is able to prevent an increase of SAR value in a human head by the electromagnetic waves.

While this invention has thus far been described in specific conjunction with only several embodiments thereof, it will now be readily possible for one skilled in the art to put this invention into effect in various other manners. For example, in the above embodiments, an earphone system of the present invention was described as regards such an earphone system as used for a portable telephone. However, the earphone system of the present invention is not limited to such a use. The earphone system of the present invention can be applied to various electronic equipments for enjoying music or movies, in which an earphone or a headphone is generally used.

### INDUSTRIAL APPLICABILITY

As described above, according to an aspect of the present invention, a high-frequency current suppressor can be readily attached and fixed to an earphone, a microphone, or a signal cable used for the other electronic equipments. Therefore, unnecessary high-frequency current can be reduced sufficiently. Accordingly, the present invention is effective enough to solve various EMI problems.

Further, according to another aspect of the present invention, high-frequency current generated by electromagnetic induction can be reduced by adding a high-frequency current suppressor to at least, an earphone, a headphone or a microphone itself, alternatively, a part of a signal cable for connecting those. Accordingly, the present invention is very effective to the increase of SAR value in a human head by the electromagnetic waves that has been seriously a problem in recent years.

1. A high-frequency current suppressor comprising a flexible member capable of being attached to a cable.

2. A high-frequency current suppressor as claimed in claim 1, wherein said flexible member comprises a break which elongates over all length along an axial direction of said cable.

3. A high-frequency current suppressor as claimed in claim 1, wherein said high-frequency current suppressor comprises at least two layers which consist of a high-frequency current suppressing layer and at least one outer layer.

4. A high-frequency current suppressor as claimed in claim 3, wherein said outer layer is consisting of either a molded resin or a molded metal, or combination of said molded resin and said molded metal.

5. A high-frequency current suppressor as claimed in any one of claims 1 through 4, wherein said high-frequency current suppressor is consisting of composite magnetic material which comprises soft magnetic powder obtained by flattening alloy powder including at least Fe, Si, Al, and binding material.

6. A high-frequency current suppressor as claimed in any one of claims 1 through 4, wherein said high-frequency current suppressor is consisting of composite magnetic material which comprises soft magnetic powder obtained by flattening alloy powder including at least Ni, Fe, and binding material.

7. A high-frequency current suppressor as claimed in any one of claims 1 through 4, wherein said high-frequency current suppressor is consisting of magnetic loss thin film which comprises a first member consisting of at least any one of Fe, Co, Ni, or mixture thereof and a second member consisting of insulating material including at least more than one kinds of elements other than said Fe, Co, Ni.

8. An earphone system for use in a terminal of mobile communication, wherein said earphone system is provided with said high-frequency current suppressor as claimed in any one of claims 1 through 7.

9. An earphone system comprising a connection plug connected to an output terminal of an electronic equipment, an earphone, and a signal cable for connecting said connection plug with said earphone, wherein a high-frequency current suppressor consisting of soft magnetic material is added at least partially to any one of said connection plug, said earphone, and said signal cable.

10. An earphone system as claimed in claim 9, wherein a part or a whole of outer circumference of said signal cable is covered by said high-frequency current suppressor.

11. An earphone system as claimed in claim 9 or 10, wherein a part or a whole of outer circumference of an outer conductor of said signal cable is covered by said high-frequency current suppressor.

12. An earphone system as claimed in any one of claims 9 through 11, wherein said high-frequency current suppressor is provided near a portion where said signal cable and said earphone are connected to each other.

13. An earphone system as claimed in any one of claims 9 through 12, wherein said high-frequency current suppressor is included inside said earphone.

14. An earphone system as claimed in any one of claims 9 through 13, wherein said earphone system further comprises a microphone.

15. An earphone system as claimed in claim 14, wherein said high-frequency current suppressor is included inside said microphone.

16. An earphone system as claimed in any one of claims 9 through 15, wherein a housing of said earphone or said microphone is formed by said high-frequency current suppressor.

17. An earphone system as claimed in any one of claims 9 through 16, wherein said high-frequency current suppressor is consisting of composite magnetic material which comprises soft magnetic powder obtained by flattening alloy powder including at least Fe, Si, Al, and binding material.

18. An earphone system as claimed in any one of claims 9 through 16, wherein said high-frequency current suppressor is consisting of composite magnetic material which comprises soft magnetic powder obtained by flattening alloy powder including at least Ni, Fe, and binding material.

19. An earphone system as claimed in any one of claims 9 through 16, wherein said high-frequency current suppressor is consisting of magnetic loss thin film which comprises a first member consisting of at least any one of Fe, Co, Ni, or mixture thereof and a second member consisting of insulating material including at least more than one kinds of elements other than said Fe, Co, Ni.
